(19) United States
(12) Patent Application Publication
(10) Pub. No.: US 2012/0241252 A1
(43) Pub. Date: Sep. 27, 2012

(54) EVACUATION SYSTEM, IN PARTICULAR FOR HIGH-RISE BUILDINGS

(76) Inventor: David Urban, Eschweiler (DE)

(21) Appl. No.: 13/509,280

(22) PCT Filed: Oct. 19, 2010
(86) PCT No.: PCT/DE10/01211

§ 371 Date: Jun. 11, 2012

(30) Foreign Application Priority Data
Oct. 26, 2009 (DE) 10 2009 050 705.1

(51) Int. Cl. A62B 1/00

(52) U.S. Cl. 182/48

(57) ABSTRACT

The invention relates to an evacuation system, in particular for high-rise buildings, comprising at least one vertically arranged sliding profiled element (1) having a guide channel (8), wherein said sliding profiled element is arranged on the outside wall of a building and is provided for accommodating sliding elements (4) arranged at a distance from each other for transporting persons, at least one decelerating device (5) being provided along the vertical sliding profiled element, wherein said at least one decelerating device reduces at least in some sections the speed of the sliding elements moving downward on the vertical sliding profiled element (1). The evacuation system is characterized by the following characteristics:
a) in addition to the vertical sliding profiled element (1), the evacuation system comprises at least one further sliding profiled element (2), which is substantially horizontally arranged and which is connected to the vertical sliding profiled element by means of a connecting sliding profiled element (3) that is curved at least in some sections;
b) furthermore, at least one decelerating device (5, 6) is provided that allows a sliding element to be braked depending on one or more sliding elements located in, above, and/or below the connecting section or connecting area (A) of the connecting sliding profiled element (3) and the vertical sliding profiled element and/or one or more sliding elements located in the sliding profiled element and/or in the connecting sliding profiled element.

### TECHNICAL FIELD

The present invention relates to a novel evacuation system, in particular for high-rise buildings or other occupied high-rise structures, comprising at least a vertically arranged sliding profiled element having a guide channel, which is disposed on the outside wall of a building, and which accommodates spatially separated sliding elements for transporting persons from a danger zone during an emergency, wherein at least one decelerating device is provided along the vertical sliding profiled element which reduces at least in some sections the speed of the sliding elements moving downward on the vertical sliding profiled element.

### BACKGROUND

DE 37 34 463 A1 discloses a rescue device, especially for the evacuation of high-rise buildings during emergencies, which consists of a sliding rail that is arranged at a distance from the outside wall of a building and extends to the floor. Spaced apart door units for inserting sliding elements into a guide channel are provided at the sliding rail. Further, in a rear section of the sliding rail a number of deceleration elements are arranged, which have a planar friction surface and a back side. On the sliding element, a handle and a loop are provided, into which a belt is hooked, on which a user can slide down along the sliding rail to the floor.

The disadvantage of this device is primarily, that it only comprises a vertically arranged sliding rail along a building. This makes it difficult to safely enter the rescue device, since access is only possible on the outside. The sliding elements have to be laterally manually inserted into the door units of the guide channel, which is disadvantageous, since—especially during first use—parts of the sliding elements may get caught at those entry openings. Even if a sliding element is smoothly inserted, a non-trivial delay may occur for a person to enter the rescue device. Another difficulty is the smooth entering of persons in distress into a vertical sliding rail, since downward sliding rails have to be stopped, if persons below insert sliding elements into the guide channel. This unavoidably leads to a constant backup; evacuation of persons in distress cannot flow smoothly with this device.

Further, U.S. Pat. No. 4,406,349 A discloses an emergency escape apparatus, which also consists of a sliding rail that is vertically arranged along a house wall. The sliding element according to that invention is disposed laterally in guide rails. A deceleration device in form of a brakable gear, which moves in spaced apart cut-outs along the slide rail. The user can slow down the sliding element by activating the braking device at the gear using a wire, a rope, or the like.

In addition to the identified drawbacks of exclusively vertically oriented sliding rails this apparatus poses considerable danger, since the braking system is controlled only by the user. Especially while in distress, persons may either panic and completely block the sliding element, or not activate the braking device at all.

### SUMMARY

The present disclosure provides an evacuation system, which eliminates the aforementioned disadvantages, which can be embarked and used without any risks, and which prevents a backup from forming during a rescue operation. An objective of the disclosure is to enable a rescue operation which is automatically controlled—preferably by machine and not manually—and which runs at a substantially constant speed. In technical terms, the system should require little design effort and be easy to install and maintain.

The foregoing objective is achieved by the features of the independent claim. Advantageous embodiments of the evacuation system are provided in the dependent claims.

Accordingly, an evacuation system of the aforementioned type is characterized by the following features:
a) In addition to the vertical sliding profiled element the evacuation system comprises at least one other substantially horizontally arranged sliding profiled element, which is connected to the vertical sliding profiled element by means of a at least partially curved—preferably by 90°—connecting sliding profiled element. Horizontal sliding profiled element, connecting sliding profiled element, and vertical sliding profiled element are configured and connected to each other such that a sliding element can slide in a smooth sliding action from one profiled element to the next.
b) At least one decelerating device is provided in the horizontal sliding profiled element and/or the connecting sliding profiled element that allows a sliding element to be decelerated depending on one or more sliding elements located in, above, and/or below the connecting section or connecting area of the connecting sliding profiled element and the vertical sliding profiled element and/or one or more sliding elements located in the sliding profiled element and/or in the connecting sliding profiled element. I.e., the at least one decelerating device is controlled to reduce the speed of sliding elements that slide by depending on the presence of one or more sliding elements being located in sliding profiled elements in proximity of the decelerating device.

The decelerating device may be mechanically or electronically controlled or switched by means known in the art (mechanical or electronic switch, light barrier, etc.).

This novel embodiment of an evacuation system ensures a continuously smooth rescue operation, since the control of the sliding elements by the decelerating device(s) at the crucial connection sections prevents congestions or backups in the sliding profiled elements.

At least the decelerating device at the vertical sliding profiled element consists of a plurality of superimposed cylindrical shaped bodies (rollers) disposed in the guide channel, which rest with their friction surface on the sliding elements that slide by. The cylindrical shaped bodies (rollers) each comprise a gear or a pulley, which engage a series of movable interlinked or pivotally connected members (chain) or a toothed belt that is arranged in or at the guide channel.

Advantageously, a centrifugal brake is provided at least at one gear or pulley. Any centrifugal brake known in the art may be used. The centrifugal brake may e.g. comprise a rotating member disposed at the corresponding gear or pulley and at least partially enclosed by a brake drum, with substantially radially movable centrifugal brake shoes being arranged between the rotary member and an inner wall of the brake drum. The centrifugal brake shoes are triggered by centrifugal force moving them radially-outwardly from a rest position when the rotating member exceeds a predetermined speed. Brake pads may be provided between the centrifugal brake shoes and the brake drum to increase friction required for braking the sliding elements. The brake pads can be attached either to the centrifugal brake shoes or on the inner wall of the brake drum. It should be possible to brake the gear of the pulley to a complete stop.

The evacuation system preferably comprises several modules, for example each floor of a building may preferably have one module consisting of a vertical sliding profiled element, a connecting sliding profiled element and a horizontal sliding profiled element. The modules are mounted at a predetermined distance from the building wall in such a way, that the horizontal sliding profiled elements of a respective building floor can be easily accessed from below.

Each horizontal sliding profiled element (i.e. each floor) is preferably accessible at a station. The sliding elements are inserted into the guide channel from below through a receptacle at the station, e.g. a designated window outlet or other outlet opening at the building. Alternatively, a sufficient number of sliding elements are provided in the guide channel or a dedicated container or the like, wherein the sliding elements in the guide channel are automatically transported to the station one after another as needed, without having to be inserted by hand into a receptacle. This alternative embodiment has the particular advantage that there is no difficulty in transporting the sliding elements even in a panic situation, thereby guaranteeing a smooth and fluent rescue operation.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 is a perspective view of a partial section of the evacuation.

FIG. 2 is a perspective view of a partial section of the vertical sliding profiled element 1.

FIG. 3 is a schematic view of the evacuation system from different sides.

FIG. 4 is a partial cross section of the vertical sliding profile element 1.

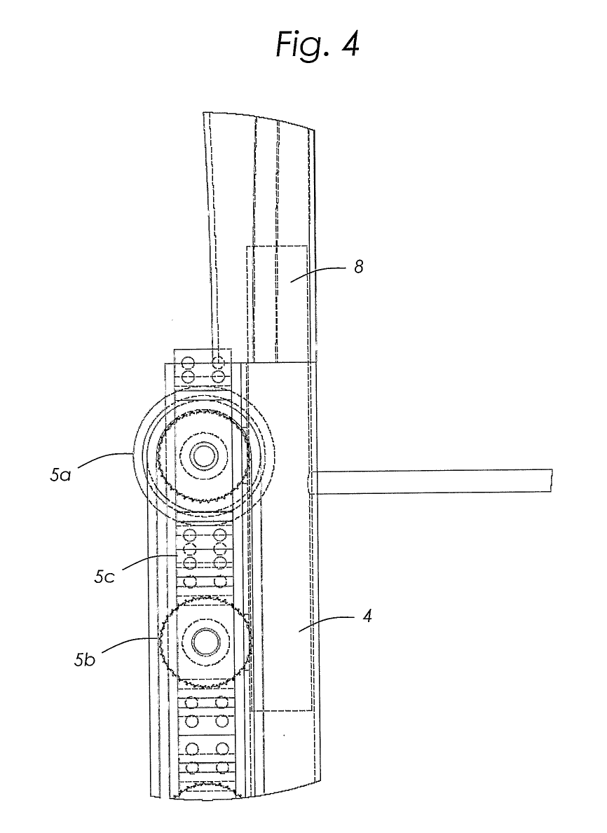

FIG. 5 is a perspective view of the sliding element 4.

### DETAILED DESCRIPTION

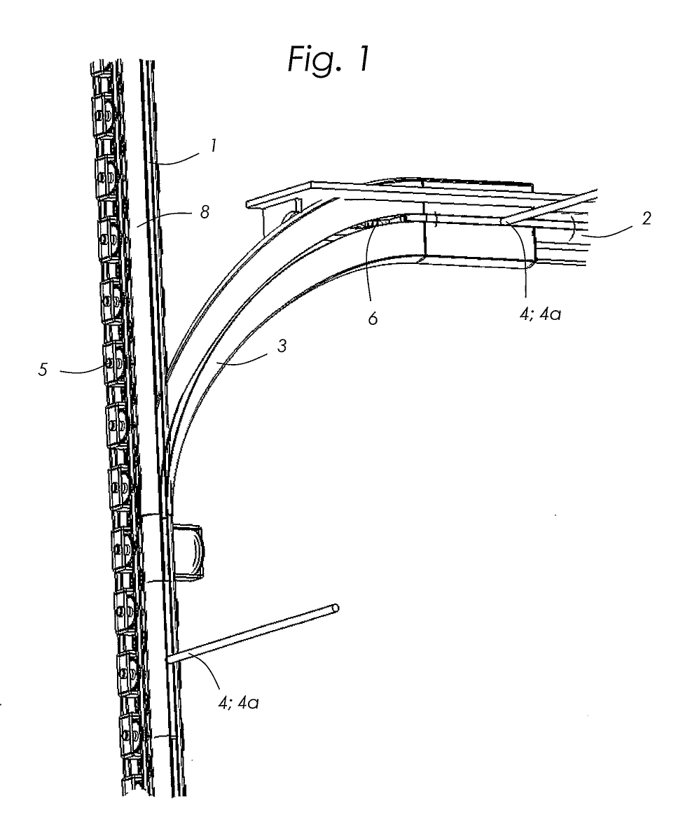

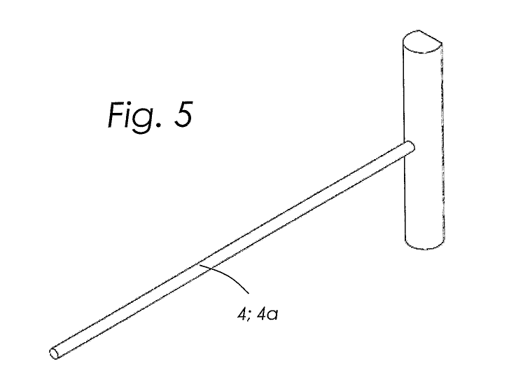

FIG. 1 is a perspective view of a partial cutout of the evacuation system according to the invention in a preferred embodiment. As shown in FIG. 1 and FIG. 5, the sliding element 4 comprises a rod-shaped attachment or a rod 4a, which is use to attach a person—or preferably a person in a harness or the like. Guide slots 9 which guide rod 4a of the sliding element 4 are laterally provided along the sliding profiled elements 1, 2, 3, and exactly end in the guide slots 9 of the respective following profiled elements 1, 3.

The embodiment of the evacuation system illustrated in FIG. 1 comprises three sliding profiled elements 1, 2, 3, wherein the connecting sliding profiled element 3 is firmly welded or screwed to the sliding profiled element 1, because in the connecting portion or area A the sliding profiled elements 1, 3 are exposed to strong forces, in particular in the transition region. The horizontal sliding profiled element 2 may, however, simply be plugged into the connecting sliding profiled element 3. Alternatively, the connecting sliding profiled element 3 may also be part of the horizontal sliding profile 2, or connecting profiled element 3 and horizontal sliding profiled element 2 may be formed as one body.

A decelerating device 6 is arranged within the connecting profiled element 3 in the embodiment illustrated in FIG. 1.

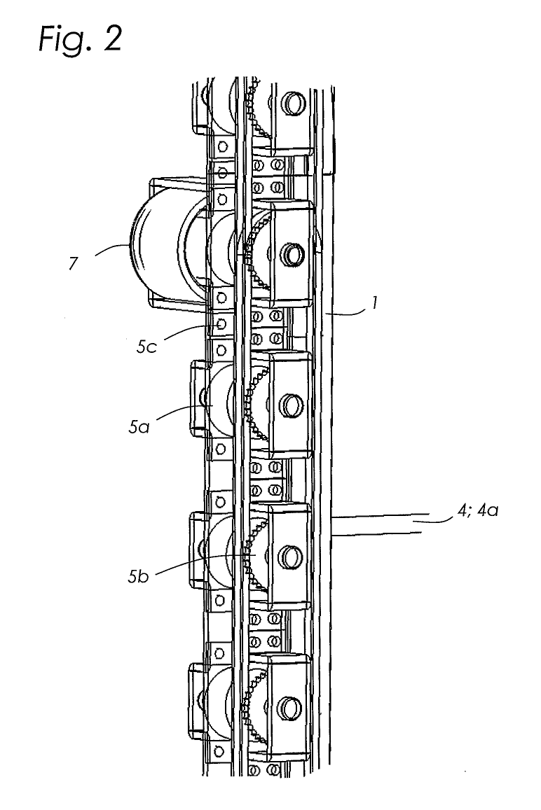

FIG. 2 is a perspective view of a partial section of the vertical sliding profiled element 1. As shown, the evacuation system comprises a decelerating device 5, which consists of rollers 5a that are arranged in the guide channel 8 along the vertical sliding profiled element 1, and which each are equipped with a gear 5b and run in a toothed belt 5c.

Provided at a gear 5b is a centrifugal brake 7, which activates when the gears exceed a predetermined speed, and which brakes belt 5c by means of a gear which is connected to the centrifugal brake 7 by an axis.

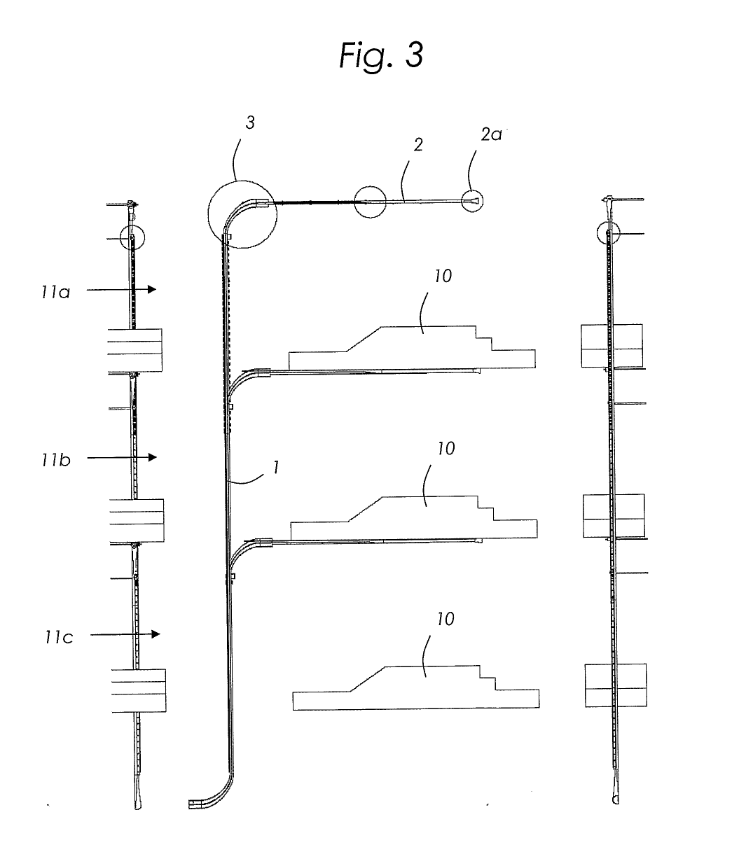

FIG. 3 is a schematic view of the evacuation system from different sides. The evacuation system presented here comprises three stacked levels 11a, 11b, 11c. An entry platform 10 is provided at the building preferably each above the lower and accordingly spaced below the horizontal sliding profiled element 2, by which persons can easily be attached to the sliding elements 4. The operation of the evacuation system is preferably effected in the following steps:

First the person to be rescued is secured in a rescue harness or a sit harness, which is attached to the sliding element 4 by a cable or the like or to a carabiner or the like which is connected to the sliding element. The person then slides—due to gravity, for example, by a slight inclination of the horizontal sliding profiled element 2—along the sliding profiled element 2 to the connecting sliding profiled element 3. Provided that no further sliding element 4 is in the connecting portion or area A, the sliding element 4 is released and slides into the vertical sliding profiled element 1.

The control of the deceleration devices 5 and 6 can also be carried out in such a way that the persons or the sliding elements 4 are alternately forwarded or guided in the vertical sliding profiled element 1 (zipper method). Especially in panic situations, this may serve to calm the distressed persons.

In another embodiment, it is also conceivable, to initially release only the profiles 1, 2, 3 for persons who are in acute danger to life, for example, in an area of the building where a fire has spread to almost the entire floor, whereas a lower floor is not in imminent danger.

In the embodiment shown in FIG. 3 a funnel-shaped receptacle 2b is provided at the end of horizontal sliding profiled element 2, which serves for the easy insertion of sliding elements 4.

The evacuation system according to the invention is not limited in its application to the preferred embodiments set forth above. Instead, a multitude of design variations can be imagined which make use of the solution, even in fundamentally different designs. While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

### LIST OF REFERENCE NUMERALS

1 vertical sliding profiled element
2 horizontal sliding profiled element
2b funnel-shaped receptacle at 2
3 connecting sliding profiled element
4 sliding element
4a rod
5 decelerating devices at 1
5a rollers
5b gears
5c belt
6 decelerating devices at 1
7 centrifugal brake
8 guide channel
9 guide slot
10 entry platform
11a, 11b, 11c levels

1.-10. (canceled)

11. An evacuation system for rescuing persons from high-rise buildings and other high-rise structures, comprising
sliding profiled elements, comprising
at least one substantially vertically arranged sliding profiled element disposed on an outside wall of a building and
at least one substantially horizontally arranged sliding profiled element connected to the substantially vertically arranged sliding profiled element by an at least partially curved connecting sliding profiled element;
sliding elements for transporting persons from a danger zone during an emergency configured to slide at a distance from each other within a guide channel created by the sliding profiled elements; and
at least one decelerating device disposed along the sliding profiled elements for reducing at least in one section the speed of the sliding elements sliding in the sliding profiled elements, wherein
the at least one decelerating device comprises a plurality of cylindrical shaped bodies which are arranged within the guide channel and connected by a plurality of movable interlinked or pivotally connected members or a toothed belt;
each of the cylindrical shaped bodies comprises a gear or a pulley which engages the plurality of movable interlinked or pivotally connected members or the toothed belt;
each of the cylindrical shaped bodies comprises a friction surface which rests on the sliding elements that slide by; and
the at least one decelerating device is controlled to reduce the speed of sliding elements that slide by depending on the presence of one or more sliding elements being located in sliding profiled elements in proximity of the decelerating device.

12. The evacuation system as in claim 11, wherein the partially curved connecting sliding profiled element is curved by 90 degrees.

13. The evacuation system as in claim 11, further comprising a centrifugal brake having a gear or a pulley which engages the plurality of movable interlinked or pivotally connected members or the toothed belt and is configured to brake the cylindrical shaped bodies upon exceeding a predetermined speed.

14. The evacuation system as in claim 13, wherein
the centrifugal brake comprises
a rotating member disposed at the centrifugal brake's gear or pulley;
a brake drum at least partially enclosing the rotating member; and
substantially radially movable centrifugal brake shoes arranged between the rotating member and an inner wall of the brake drum, wherein the substantially radially movable centrifugal brake shoes activate upon exceeding a predetermined speed of the rotating member.

15. The evacuation system as in claim 14, further comprising brake pads between the centrifugal brake shoes and the brake drum.

16. The evacuation system as in claim 11, further comprising a plurality of pre-inserted sliding elements located in the guide channel or a dedicated container which are automatically transported to a station one after another as needed.

17. The evacuation system as in claim 11, wherein guide slots for guiding rods of the sliding elements are laterally provided along the sliding profiled elements such that the guide slots of connected sliding profiled elements are exactly leading into each other.

18. The evacuation system as in claim 11, comprising two or more decelerating devices which are controlled such that sliding elements are alternately forwarded into the vertical sliding profiled element according to a zipper method.

19. The evacuation system as in claim 11, comprising at least two substantially horizontally arranged sliding profiled elements at different building floors, wherein initially only one of the substantially horizontally arranged sliding profiled elements is released to allow sliding elements to enter the at least one substantially vertically arranged sliding profiled element, whereby priority is given to rescue persons located on a floor where they in acute danger to life over those located on different floor.

20. The evacuation system as in claim 11, further comprising a funnel-shaped receptacle configured to allow easy insertion of a sliding element, the funnel-shaped receptacle being located at an end of the substantially horizontally arranged sliding profiled elements opposite the connecting sliding profiled element.
